(19) United States
(12) Patent Application Publication
(10) Pub. No.: US 2013/0185036 A1
(43) Pub. Date: Jul. 18, 2013

(54) METHOD AND APPARATUS OF USING DRIVE TEST DATA FOR PROPAGATION MODEL CALIBRATION

(71) Applicant: China Mobile Communication Corp., Beijing (CN)

(72) Inventors: Yusheng Zhang, Beijing (CN); Sheng Zhou, Beijing (CN); Chenguang Wei, Beijing (CN); Li Zhang, Fuzhou (CN); Peng Gao, Beijing (CN); Wuije Hu, Beijing (CN); Yanyun Zhu, Beijing (CN); Wenhua Ma, Beijing (CN); Pei Zhao, Beijing (CN); Yaxi Hu, Beijing (CN); Hongbin Jin, Beijing (CN); Jing Yuan, Beijing (CN); Bin Zhang, Beijing (CN); Hanhui Wei, Fuzhou (CN); Hai Fu, Fuzhou (CN)

(73) Assignee: CHINA MOBILE COMMUNICATION CORP., Beijing (CN)

(21) Appl. No.: 13/788,610

(22) Filed: Mar. 7, 2013

Related U.S. Application Data
(63) Continuation of application No. 12/260,847, filed on Oct. 29, 2008, now abandoned.

(30) Foreign Application Priority Data
Oct. 29, 2007 (CN) 200710176500.0

(51) Int. Cl. G06F 17/50

(52) U.S. Cl. CPC G06F 17/5009
USPC 703/2

(57) ABSTRACT

A method using drive test data for propagation model calibration includes: step 1, obtaining original drive test data; step 2, selecting the data from the drive test data according to predefined conditions as effective drive test data; and step 3, extracting the effective drive test data to form a data file used for propagation model calibration. An apparatus using drive test data for propagation model calibration includes: a drive test data obtaining module, configured to obtain the drive test data in the regions to be calibrated; an effective drive test data generation module, configured to generate effective drive test data from the drive test data according to predefined conditions; and a data file generation module, configured to extract the effective drive test data to form a data file used for propagation model calibration. The present invention utilizes drive test data of existing networks to largely decrease the CW test work and reduce the network building cost. It is believed that the calibrated model can relatively accurately reflect the propagation characteristics in the field. Furthermore, base stations can be optimally allocated.

### CROSS-REFERENCE TO RELATED APPLICATIONS

This patent application makes reference to, claims priority to and claims benefit from U.S. patent application Ser. No. 12/260,847 filed on Oct. 29, 2008, and Chinese Patent Application No. 200710176500.0 filed on Oct. 29, 2007, which written description is incorporated herein by reference.

### FIELD OF THE INVENTION

The present invention relates to mobile communication field, and more particularly, to a method and an apparatus for propagation model calibration by using drive test data instead of specific Continuous Wave (CW) required in network planning, design and optimization.

### BACKGROUND OF THE INVENTION

Along with the wireless network and wireless environments gradually being more complex, anticipating the coverage by base station signals becomes a key and necessary step in network planning, design and optimization, etc., and it will directly influence the performances in respects such as final network coverage, capacity and quality. Currently, to anticipate the network coverage, it generally selects an appropriate electromagnetic wave propagation model and performs CW test in specific locations to obtain the data and conduct propagation model calibration.

“Pilot Measurement Method-Effective Method for Propagation Module Calibration in CDMA Network”, published by Designing Techniques of Posts and Telecommunications, iss. 4, pages 1-6, April 2004, discloses processes of CDMA pilot channel test and propagation model calibration by describing the process of CW test and the method of using CW data for propagation model calibration.

“Method for Propagation Model Calibration based on Pilot Channel”, published by Radio Engineering of China vol. 34, iss. 5, pages 13-14, 2004, discloses a method of calculating path loss based on Ec/Io in a CDMA forward pilot channel and further conducting propagation model calibration by linear regression iteration algorithm;

Chinese patent publication No. CN 1529445, titled “Method for Calibrating Radio Propagation Model in CDMA System”, discloses a process and a method for calibrating drive test data in a CDMA pilot channel by using a non-linear regression iteration algorithm.

However, the above methods have problems such as follows.

It fails to count in the problem that the sampling rate of a drive test terminal is far lower than that of a CW test receiving device, and thus results in the problem that the sampled data are not sufficient to reflect the real region propagation characteristics.

It fails to provide exact requirements to utilize drive test data to perform propagation model calibration, but directly use the analysis for CW test disclosed by “Principle and Design for Mobile Communication”, 1^{st} Edition, SAGE Publication, August 1990, and yet, it fails to specify what data can be used and what data should be filtered and further processed within the obtained drive test data.

It cannot utilize the previous obtained drive test data, bur requires separate drive test for the propagation model calibration.

Those methods can only be applied in a narrow range. Only CDMA systems are considered, and it fails to form a complete set of method and system of using drive test data for propagation model calibration. Therefore, those methods can not be widely used.

### SUMMARY OF THE INVENTION

A large amount of drive test data are accumulated after the existing network were built up. Those data actually reflect the field strength distribution in the region. In order to use the drive test data for propagation model calibration and further for wireless communication network building and optimization, the present invention provides a method of using drive test data for propagation model calibration, comprising:

Step 1: obtaining original drive test data;

Step 2: selecting data from the original drive test data according to predefined conditions as effective drive test data; and

Step 3: extracting the effective drive test data to form a data file used for propagation model calibration.

In Step 1, the original drive test data are obtained based on the time of drive test required by propagation model calibration or data amount required by propagation model calibration.

The time of drive test required by propagation model calibration is calculated by

car speed/(required sampling rate×real sampling rate of drive test terminals×the number of the terminals used for repeated drive test in the region); or

(the number of samples×car speed)/(the length of sampling window×real sampling rate of drive test terminals×the number of the terminals used for repeated drive test in the region).

The data amount required by propagation model calibration is calculated by

the real route length during drive test/the required sampling rate; or

(the number of samples×the real route length during drive test)/the length of sampling window.

When the original drive test data are obtained based on the time of drive test required by propagation model calibration, between Step 2 and Step 3, the method further comprises:

Step 2′: comparing the times of drive test required by propagation model calibration with the times of drive test in real test, if the times of drive test in real test is larger than or equal to the times of drive test required by propagation model calibration, data sufficiency is met and Step 3 is executed. Otherwise, returning to Step 1 to obtain more data.

When the original drive test data are obtained based on the data amount required by propagation model calibration, between Step 2 and Step 3, the method further comprises:

Step 2″: comparing the data amount required by propagation model calibration with the effective data amount obtained in Step 2, if the effective data amount obtained in Step 2 is larger than or equal to the data amount required by propagation model calibration, data sufficiency is met and Step 3 is executed. Otherwise, returning to Step 1 to obtain more data.

The effective drive test data satisfy the following predefined conditions:

including longitude and latitude information;

including signal strength information, and the signal strength being within a signal strength requirement range;

including identification information of cells, and the identification information of cells are the same with the identification information of cells to be tested.

The effective drive test information is not repeated.

The data file in Step 3 comprises the following information: signal strength and the corresponding longitude and latitude.

The present invention further provides an apparatus for using drive test data for propagation model calibration, including:

a drive test data obtaining module, configured to obtain the drive test data in a region to be calibrated;

an effective drive test data generation module, configured to generate effective drive test data from the drive test data according to predefined conditions;

a data file generation module, configured to extract the effective drive test data to form a data file used for propagation model calibration.

The drive test data obtaining module obtains the original drive test data based on the time of drive test required by propagation model calibration or data amount required by propagation model calibration.

The effective drive test data satisfy the following predefined conditions:

including longitude and latitude information;

including signal strength information, and the signal strength being within a signal strength requirement range;

including identification information of cells, and the identification information of cells are the same with the identification information of cells to be tested.

The effective drive test information is not repeated.

The data file comprises the following information: signal strength and the corresponding longitude and latitude.

Compared with the prior art, the present invention has the following advantages. The present invention fully utilizes the drive test data in the existing networks, thereby largely decreasing the CW test work and reducing the network building cost. Moreover, it is guaranteed that the calibrated model can relatively accurately reflect the propagation characteristics in the field. And, the base stations can be optimally allocated accordingly.

### BRIEF DESCRIPTION OF THE DRAWINGS

FIG. 1 is a flowchart according to the present invention;

FIG. 2 is a flowchart showing a method of using drive test data for propagation model calibration according to the first embodiment of the invention;

FIG. 3 is a flowchart showing a method of using drive test data for propagation model calibration according to the second embodiment of the invention;

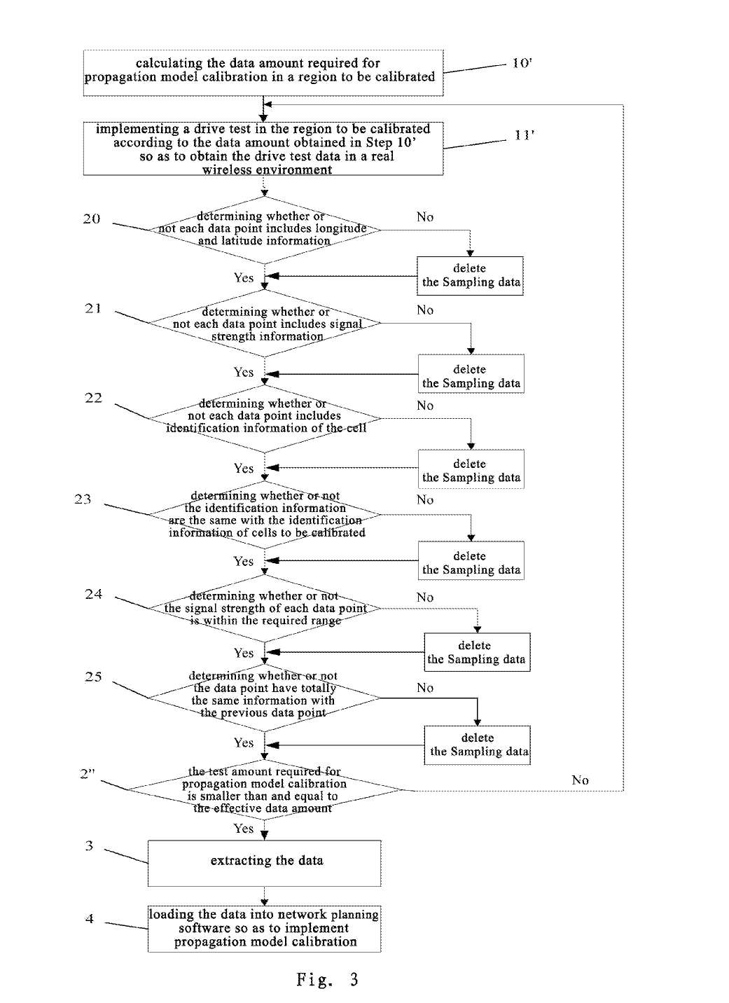

FIG. 4 is a configuration diagram showing an apparatus of using drive test data for propagation model calibration according to the invention.

### DETAILED DESCRIPTION OF THE INVENTION

In the present invention, the existing drive test data is processed with certain method and further applied for propagation model calibration.

The present invention will be detailed explained by reference to the embodiments of the present invention in connection with the accompanying drawings.

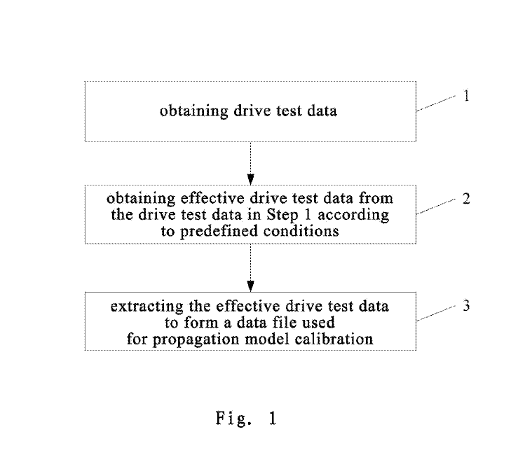

As shown in FIG. 1, FIG. 1 is a flowchart according to the invention, including the following steps:

Step 1: obtaining drive test data;

Step 2: obtaining effective drive test data from drive test data in Step 1 according to predefined conditions; and

Step 3: extracting effective drive test data to form data file used in propagation model calibration.

### First Embodiment

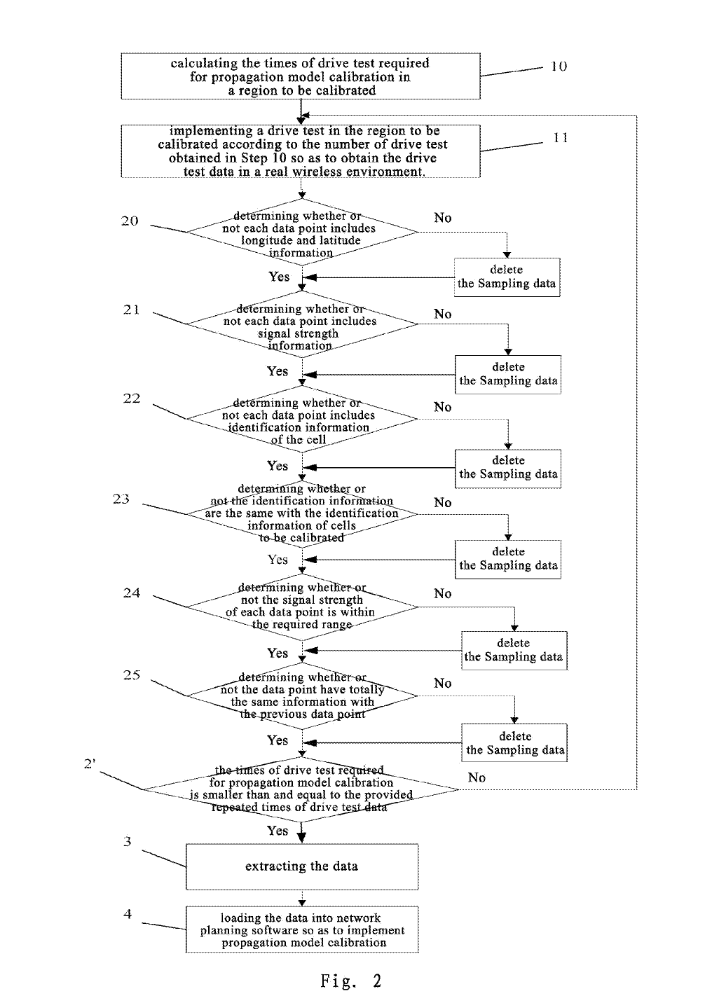

As shown in FIG. 2, FIG. 2 is a flowchart showing the method of using drive test data for propagation model calibration according to the first embodiment of the present invention. The process in FIG. 2 includes the following steps.

The above step 1 of obtaining drive test data further includes the following steps.

Step 10: calculate the times of drive test required for propagation model calibration in a region to be calibrated.

According to the theory in “Pilot Measurement Method-Effective Method for Propagation Module Calibration in CDMA Network” published by Designing Techniques of Posts and Telecommunications, iss. 4, pages 1-6, April 2004, it is concluded that the times of drive test required for propagation model calibration can be calculated with relative information during drive test, such as sampling rate of terminals, transmitting frequency, car speed, resolution requirement and the like. It may be expressed by the formula:

times of drive test required for propagation model calibration=car speed/(required sampling rate×real sampling rate of drive test terminals×the number of the terminals used for repeated drive test in the region)

(the number of samples×car speed)/(the length of sampling window×real sampling rate of drive test terminals×the number of the terminals used for repeated drive test in the region),

wherein, the number of terminals is the number of cell phones.

The length of the sampling window depends on the frequency of the real drive test system. If the frequency is lower than 200 MHz, the length of the sampling window is 20 times of wavelength. Otherwise, the length of the sampling window is 40 times of wavelength. Commonly 40 times of wavelength is used in the mobile communication system working between 800 MHz and 2000 MHz.

The number of samples is between 36 and 50 so that sampling confidence interval of 90% to 99% can be guaranteed. If the sampling confidence interval is beyond this range, error will be further increased and even data is not reliable.

The unit of car speed is m/s.

The unit of real sampling rate of drive test terminals is number-of-terminal/s.

The number of the terminals used for repeated drive test in the region is the number of terminals which are parallel tested in the region to be calibrated during drive test. The repeating of drive test may not be at the same time, but it is required to be taken in the same region and route.

Step 11: perform drive test in the region to be calibrated based on the number of drive test obtained in Step 10, to obtain the drive test data in the real wireless environment.

Here, the drive test data are obtained by testing common channels for broadcasting base station information in the wireless system. The drive test data may include, but are not limited to, longitude and latitude, test time, identification numbers of the local cell and adjacent cells, signal strength (level) of the local cell, signal strength (level) of adjacent cells. Specifically, only if the data includes longitude and latitude, test time, identification numbers and signal strength (level) of the local cell, of each point along the test route, it can be used as effective data for further propagation model calibration. The terminals maybe idle or in conversation during drive test.

Step 2: perform efficiency judgment to the drive test data. Obtain effective drive test data from the drive test data obtained in Step 11 according to predefined conditions.

In this Step 2, efficiency judgment is a process to judge and filter unreasonable data. During the process, the data without longitude and latitude, without signal strength value, without the identification number of the cell to be calibrated, or with the signal strength beyond specific range, etc., which can not be used for propagation model calibration, will be deleted.

This Step 2 further includes the following steps.

Step 20: determine whether or not each data point in the drive test data includes longitude and latitude information; if there is data without longitude and latitude, delete this data point.

Next, part drive test data obtained in some test in a GSM system are taken as an example to explain the process to obtain effective drive test data. Table 1 is a collected drive test data table (the identification numbers of cells to be calibrated are 45 and 99). As shown in Table 1, the data in the first line have not longitude and latitude information. Therefore, the data in the first line is not usable and should be deleted.

TABLE 1
Drive Test Data Table

| | | | | | | |
|---|---|---|---|---|---|---|
| | | 13:37:04 | 45 | −70 | 99 | −88 |
| 114.05608 | 22.47466 | 13:37:14 | 45 | | 99 | |
| 114.05606 | 22.47461 | 13:37:24 | | −70 | | −88 |
| 114.05604 | 22.47456 | 13:37:34 | 50 | −70 | 90 | −88 |
| 114.05602 | 22.47451 | 13:37:44 | 50 | −70 | 99 | −88 |
| 114.05602 | 22.47451 | 13:37:54 | 45 | −20 | | |
| 114.05602 | 22.47451 | 13:37:54 | 45 | −125 | | |
| 114.05602 | 22.47451 | 13:38:04 | 45 | −68 | 99 | −88 |
| 114.05602 | 22.47451 | 13:38:04 | 45 | −68 | 99 | −88 |
| 114.05602 | 22.47451 | 13:38:04 | 45 | −68 | 99 | −88 |

In Table 1, with the order from left to right,

The first column represents longitude LON;

The second column represents latitude LAT;

The third column represents test time TIME;

The fourth column represents identification of main service cell BSIC_SERV;

The fifth column represents receiving level of main service cell RXLEV_F;

The sixth column represents identification of the first adjacent cell BSIC_N1;

The seventh column represents receiving level of the first adjacent cell RXLEV_N1.

It should be understood that the data obtained by testing with different test equipments in different communication systems are different in respects of data name, arrangement order, the number of data and the like. However, those differences are not apart from the principle of the invention and do not affect the understanding of the invention.

Step 21: determine whether or not each data point in the drive test data includes signal strength information; if neither of the main cell and adjacent cells have signal strength information, delete the data point.

For example, the data in the second line in Table 1 does not have signal strength information, and thus the data in this line are not usable and should be deleted.

Step 22: determine whether or not each data point in the drive test data includes identification information of the cell; if neither of the main cell and adjacent cells have identification information, or if the identification information is not the identical with the cells to be calibrated, delete the data point.

For example, the data in the third line in Table 1 dose not have identification information, and thus the data in this line are not usable and should be deleted.

Step 23: determine whether or not the identification information are identical with the identification information of cells to be calibrated cell; if the identification information of the main cell and adjacent cells are not identical with the cells to be calibrated, delete the data point.

For example, the data in the fourth line of Table 1 have the identification information different from the identification of the cells to be calibrated, thus the data in this line are not usable and should be deleted. However, the data in the fifth line have the identification information partly identical with the identification of the cells to be calibrated, and thus the data can be left.

Step 24: determine whether or not the signal level of each data point is within the range required for signal strength; if beyond the range, delete the data point.

In this embodiment, the range required for signal strength is set by −40 dB to -110dB. The data in the sixth line and the seventh line of Table 1 have the signal strength beyond the range; therefore, the data are not usable and should be deleted.

Step 25: determine whether or not the data point have totally the same longitude and latitude, time, identification of cells, signal strength with the previous data point; if it is the same, delete the data point.

For example, the data in line 9 and line 10 are totally the same with the data in line 8. Therefore, the data in line 9 and line 10 are not usable and should be deleted.

Step 3: based on the identification of the cells to be calibrated, extract the signal strength in the data file formed in Step 2 and the corresponding longitude and latitude to form a data file used for propagation model calibration.

As shown in Table 2, Table 2 shows the extracted data based on the identification of the cells to be calibrated 45 and 99.

TABLE 2
Extracted Data Based on Identification of Cells to Be
Calibrated 45 and 99

| LON | LAT | RXLEV_N1 |
|---|---|---|
| 114.056020 | 22.474510 | −70 |
| 114.056020 | 22.474510 | −68 |

Test data extracting is performed by extracting part data of the cells to be calibrated required for propagation model calibration from the drive test data, such data including longitude and latitude, and signal strength information of the test point within the region.

After obtaining the data file used for propagation model calibration in Step 3, Step 4 is executed. The data file used for propagation model calibration is output to network planning software so as to implement propagation model calibration. The process of propagation model calibration is basically the same with the process of propagation model calibration after CW test. However, during propagation model calibration by using the drive test data, the data file, information of cells to be calibrated and the corresponding antenna data formed in Step 3 are required to be loaded.

In order to further increase the accuracy of data, a step is can be performed between Step 2 and Step 3.

Step 2′: determine whether or not filtered data amount can satisfy the requirement.

Namely, compare the times of drive test required for propagation model calibration calculated in Step 10 with the provided repeated times of drive test data; if the latter is larger than or equal to the former, it can be regarded the data sufficiency is satisfied. Otherwise, data sufficiency is not satisfied, and return to Step 2.

### Second Embodiment

The difference between this embodiment and the first embodiment is that the drive test data in the region to be calibrated are obtained according to different dependence. In this embodiment, the dependence is the data amount required for propagation model calibration in the region to be calibrated.

According to the theory in “Pilot Measurement Method-Effective Method for Propagation Module Calibration in CDMA Network” published by Designing Techniques of Posts and Telecommunications, iss. 4, pages 1-6, April 2004, the data amount required for propagation model calibration can be deducted. It may be expressed by the formula:

$$data amount required for propagation model calibration = the real route length during drive test / the required sampling rate = ( the number of samples \times the real route length during drive test ) / the length of sampling window$$

Correspondingly, the times of drive test required for propagation model calibration in Step 10 in the first embodiment will be changed to the data amount required for propagation model calibration in this embodiment.

Therefore, Step 10 in the first embodiment corresponds to Step 10′ in this embodiment, calculating the data amount required for propagation model calibration in the region to be calibrated.

Step 11′, perform drive test in the region to be calibrated based on the data amount obtained in Step 10′ to obtain the drive test data in the real wireless environment.

Step 2, select the data which satisfy predefined conditions from original drive test data as effective drive test data;

Step 3, extract effective drive test data to form a data file used in propagation model calibration.

Step 2″ can be performed between Step 2 and Step 3: the data amount required for propagation model calibration which is calculated in Step 10 is compared with the filtered effective data amount obtained in Step 2; if the filtered effective data amount is larger than or equal to the data amount required for propagation model calibration, data sufficiency is met and execute Step 3. Otherwise, data sufficiency is not met and returning to Step 2.

Step 2 and 3 in this embodiment are the same with Step 2 and 3 in the first embodiment, the repeated description is not provided.

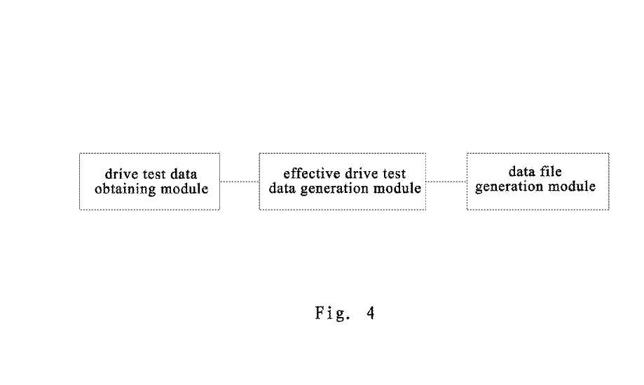

The present invention further provides an apparatus of using drive test data for propagation model calibration. As shown in FIG. 4, FIG. 4 is a configuration diagram showing to the apparatus of using drive test data for propagation model calibration according to the invention, which includes: a drive test data obtaining module, an effective drive test data generation module, and a data file generation module.

Firstly, the drive test data obtaining module calculates the times of drive test or the data amount required for propagation model calibration in the region to be calibrated based on the relative information during drive test, such as terminal sampling rate, transmitting frequency, car speed, accuracy requirement and the like; then, perform drive test in the region to be calibrated based on the required times of drive test so as to obtain the drive test data in a real wireless environment, or collect previous drive test data in the region to be calibrated based on the required data amount.

According to this embodiment,

$$Times of Drive Test = car speed / ( required sampling rate \times real sampling rate of drive test terminals \times the number of the terminals used for repeated drive test in the region ) = ( the number of samples \times car speed ) / ( the length of sampling window \times real sampling rate of drive test terminals \times the number of the terminals used for repeated drive test in the region ) ;$$

$$Data Amount = the real route length during drive test / the required sampling rate = ( the number of samples \times the real route length during drive test ) / the length of sampling window .$$

Next, the effective drive test data generation module obtains effective drive test data from the drive test data obtained by the drive test data obtaining module according to the predefined efficiency conditions.

The effective drive test data obtained by the effective drive test data generation module are output to the data file generation module. The data file generation module extracts the signal strength with the identification of the cell and the corresponding longitude and latitude from the effective drive test data to form a data file used in propagation model according to the identification of the cell to be calibrated.

The above mentioned are only the embodiments of the invention. It should be understood that those skied in the art may make variations and modifications without departing from the scope of the present invention.

1. A method for propagation model calibration, the method comprising:
obtaining original drive test data;
selecting data from the original drive test data according to predefined conditions as effective drive test data by:
deleting data without at least one of a longitude, a latitude, a signal strength value, or an identification number of a cell to be calibrated, or
deleting data with a signal strength not within a predetermined range; and
extracting the effective drive test data to form a data file used for propagation model calibration.

2. The method according to claim 1, wherein the original drive test data is obtained based on drive test times for the propagation model calibration or data amount for the propagation model calibration.

3. The method according to claim 2, wherein, the drive test times for the propagation model calibration are calculated by at least one of:
a car speed/(a required sampling rate×a real sampling rate of drive test terminals×a number of terminals used for repeated drive tests in the region to be calibrated); or
(a number of samples×car speed)/(a length of sampling window×real sampling rate of the drive test terminals×the number of terminals used for repeated drive tests in the region).

4. The method according to claim 2, wherein the data amount for the propagation model calibration is calculated by at least one of:
a real route length during a drive test/a required sampling rate; or
(a number of samples×the real route length during the drive test)/a length of sampling window.

5. The method according to claim 2, further comprising:
when the original drive test data is obtained based on the drive test times for the propagation model calibration, comparing the drive test times for the propagation model calibration with the drive test times in a real test; and
if the drive test times in the real test are larger than or equal to the drive test times for the propagation model calibration, it satisfies a data sufficiency requirement.

6. The method according to claim 2, further comprising:
when the original drive test data are obtained based on a data amount for the propagation model calibration, comparing the data amount for the propagation model calibration with an amount of the effective drive test data;
if the amount of the effective drive test data is larger than or equal to the data amount for the propagation model calibration, it satisfies a data sufficiency requirement; and
if the amount of the effective drive test data is not larger than or equal to the data amount for the propagation model calibration, obtaining original drive test data.

7. The method according to claim 1, wherein, the effective drive test data comprises data having:
longitude and latitude information;
signal strength information, wherein the signal strength information is within a signal strength requirement range; and
identification information of cells, wherein the identification information of cells is identical with the identification information of cells to be tested.

8. The method according to claim 7, wherein data of the effective drive test information is different from each other.

9. The method according to claim 7, wherein, the data file includes the following information: signal strength and corresponding longitude and latitude.

10. An apparatus using drive test data for a propagation model calibration, comprising:
a drive test data obtaining module, configured to obtain the drive test data in a region to be calibrated;
an effective drive test data generation module, configured to:
generate effective drive test data from the drive test data according to predefined conditions; and
delete drive test data without at least one of longitude and latitude, signal strength value, an identification number of a cell to be calibrated, or delete drive test data with a signal strength beyond a predetermined range; and
a data file generation module, configured to extract the effective drive test data to form a data file used for propagation model calibration.

11. The apparatus according to claim 10, wherein, the drive test data obtaining module is configured to obtain the original drive test data based on drive test times for the propagation model calibration or data amount for the propagation model calibration.

12. The apparatus according to claim 10, wherein, the effective drive test data has the following:
longitude and latitude information;
signal strength information, wherein the signal strength information is within a signal strength requirement range; and
identification information of cells, wherein the identification information of cells is identical with the identification information of cells to be tested.

13. The apparatus according to claim 12, wherein data of the effective drive test information is different from each other.

14. The apparatus according to claim 10, wherein, the data file includes the following information: signal strength and the corresponding longitude and latitude.
